(19) United States
(12) Patent Application Publication
(10) Pub. No.: US 2021/0389154 A1
(43) Pub. Date: Dec. 16, 2021

(54) METHOD AND APPARATUS FOR RECOMMENDING MAP AREA, DEVICE AND STORAGE MEDIUM

(71) Applicant: BEIJING BAIDU NETCOM SCIENCE TECHNOLOGY CO., LTD., Beijing (CN)

(72) Inventor: Wei LIU, Beijing (CN)

(21) Appl. No.: 17/355,675

(22) Filed: Jun. 23, 2021

(30) Foreign Application Priority Data
Dec. 24, 2020 (CN) 202011549000.9

(51) Int. Cl. G01C 21/36; G06F 16/2457; H04W 4/02

(52) U.S. Cl. CPC G01C 21/3679; G01C 21/3617; H04W 4/025; G06F 16/24578; G01C 21/3667

(57) ABSTRACT

A method for recommending a map area, apparatus, device and storage medium, relating to intelligent search field. The method for recommending a map area includes: obtaining an operation instruction for a map application; obtaining a current user feature and scene information corresponding to the operation instruction according to the operation instruction; determining an object to be recommended according to the current user feature and the scene information, and displaying a recommended map area corresponding to the object to be recommended on an interface of the map application, so that the map area can be recommended according to the real-time behavior of the user, and the real-time behavior of the user can be quickly reflected on the interface as the final recommended map area, realizing real-time recommendation of the map area, with high timeliness and improving the quality of the map area recommendation.

### CROSS-REFERENCE TO RELATED APPLICATIONS

This application claims priority to Chinese Patent Application No. 202011549000.9, which was filed on Dec. 24, 2020 and titled “method and apparatus for recommending map area, device and storage medium”. The disclosure of the above patent application is incorporated herein by reference in its entirety.

### TECHNICAL FIELD

The present application relates to the intelligent search field in data processing, and more particular, to a method and apparatus for recommending a map area, a device and a storage medium.

### BACKGROUND

Map area recommendation refers to map area items displayed to a user after the user opens a map or searches on the map. These items may be information points, news or videos within the map area. These items can be displayed in the form of bubbles in the map area. The user can click the corresponding bubbles according to their interests to learn more information.

The current way of the map area recommendation is to recommend a map area based on a user's fixed portrait and display it to the user. The user's fixed portrait can include information such as the user's address, the places that the user frequently visits, and so on. Items that the user may be interested in the map area are determined according to the user's fixed portrait, and updated and recommended in days.

This way of map area recommendation has poor timeliness, making the quality of the recommendation is low.

### SUMMARY

The present application provides a method and apparatus for recommending a map area, a device and a storage medium.

According to a first aspect of the present application, a method for recommending a map area is provided, including:

obtaining an operation instruction for a map application;

obtaining a current user feature and scene information corresponding to the operation instruction according to the operation instruction;

determining an object to be recommended according to the current user feature and the scene information, and displaying a recommended map area corresponding to the object to be recommended on an interface of the map application.

According to a second aspect of the present application, an apparatus for recommending a map area is provided, including:

an obtaining module, configured to obtain an operation instruction for a map application;

a processing module, configured to obtain a current user feature and scene information corresponding to the operation instruction according to the operation instruction;

a recommending module, configured to determine an object to be recommended according to the current user feature and the scene information, and displaying a recommended map area corresponding to the object to be recommended on an interface of the map application.

According to a third aspect of the present application, an electronic device is provided, including:

at least one processor; and

a memory connected in communication with the at least one processor; wherein,

the memory stores instructions that can be executed by the at least one processor, the instructions are executed by the at least one processor, to enable the at least one processor to execute the method of any one of the first aspect.

According to a fourth aspect of the present application, a non-transitory computer readable storage medium storing computer instructions is provided, wherein the computer instructions are used to enable the computer to execute the method of any one of the first aspect.

According to a fifth aspect of the present application, a computer program product is provided, the computer program product includes a computer program, the computer program is stored in readable storage medium, at least one processor of the electronic device can read the computer program from the readable storage medium, the execution of the computer program by the at least one processor enables the electronic device to execute the method according to any one of the first aspect.

The method and apparatus for recommending a map area, a device and a storage medium provided by the embodiments of the present application firstly obtain an operation instruction for a map application, the operation instruction is a real-time behavior of a user, then obtain a current user feature and scene information corresponding to the operation instruction according to the operation instruction, and determine an object to be recommended according to the current user feature and the scene information, so as to display a recommended map area corresponding to the object to be recommended on an interface of the map application. The solutions of the embodiments of the present application determine the corresponding object to be recommended through the operation instruction, so as to determine the corresponding recommended map area. Since the operation instruction is a real-time behavior of the user, the map area can be recommended according to the real-time behavior of the user, and the real-time behavior of user can be quickly reflected on the interface of the final recommended map area, realizing real-time recommendation of the map area, with high timeliness and improving the quality of the map area recommendation.

It should be understood that the contents described in this part are not intended to identify key or important features of embodiments of the present application, nor are they used to limit the scope of the present application. Other features of the present application will be easily understood by the following description.

### BRIEF DESCRIPTION OF THE DRAWINGS

Drawings are for a better understanding of the present solution and do not constitute a limitation of the present application. Among them:

FIG. 1 is a schematic diagram of an application scene provided by an embodiment of the present application;

FIG. 2 is a flow diagram of a method for recommending a map area provided by an embodiment of the present application;

FIG. 3 is a schematic diagram of a map area recommendation provided by an embodiment of the present application;

FIG. 4 is a flow diagram of obtaining a current user feature and scene information provided by an embodiment of the present application;

FIG. 5 is a flow diagram of determining an object to be recommended provided by an embodiment of the present application;

FIG. 6 is a schematic diagram of a map area recommendation provided by an embodiment of the present application;

FIG. 7 is a diagram of determining an object to be recommended provided by an embodiment of the present application;

FIG. 8 is a schematic diagram of an interface of a map area recommendation provided by an embodiment of the present application;

FIG. 9 is a structural diagram of an apparatus for recommending a map area provided by an embodiment of the present application; and

FIG. 10 is a schematic block diagram of an example electronic device provided by an embodiment of the present application.

### DESCRIPTION OF EMBODIMENTS

The following describes exemplary embodiments of the present application taken in conjunction with the accompanying drawings, including various details of embodiments of the present application for the sake of understanding, which should be considered as only exemplary. Therefore, those skilled in the art should recognize that various changes and modifications can be made to embodiments described herein without departing from the scope and spirit of the present application. Similarly, for the sake of clarity and conciseness, the description of well-known functions and structures is omitted in the following description.

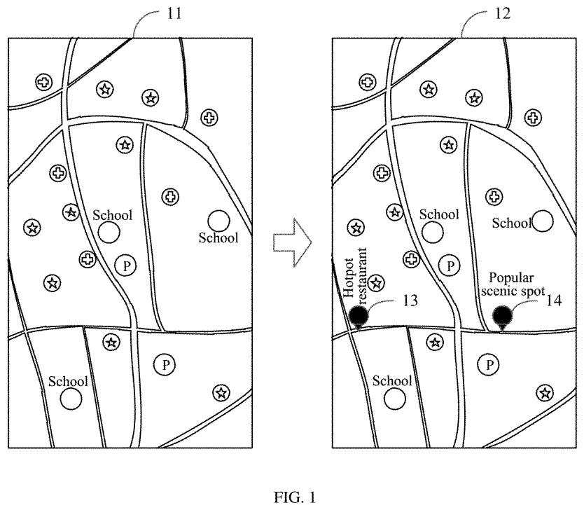

FIG. 1 is a schematic diagram of an application scene provided by an embodiment of the present application, as shown in FIG. 1, it is a map area recommendation interface diagram.

Map area recommendation refers to a map area recommendation page displayed by a map application after a user opens the map application, or after searching, clicking or other instructions on the map application.

Interface 11 is an interface before the map area recommendation on the map application. The interface 11 includes a map of one area, and a map includes different areas. Interface 12 is an interface after the map area recommendation, corresponding to interface 11.

Area displayed on the interface 12 includes various objects, which may be some point of interest (POI) within the map area, may be some feed (interfaces for receiving updates from information sources, such as interface of news, video, etc.), such as news, video, etc. in a certain area, or may be a specific location.

These objects are displayed in the form of bubbles on the interface of the map application. After being displayed to the user, in the case of the user is interested in one of the objects, he can click the bubble corresponding to the object to learn details of the object. For example, if the object is news, click the bubble corresponding to the object to read the corresponding news information, if the object is a specific location, click the bubble corresponding to the object to generate navigation information to the location, and so on.

On the interface 12, two objects, object 13 and object 14, are exemplified. Among them, the object 13 is a hotpot restaurant and the object 14 is a popular scenic spot. The two objects are displayed in the form of bubbles on the interface 12, and there are corresponding text descriptions around the bubbles, namely “hotpot restaurant” and “popular scenic spot”. Users can click the bubbles to learn the corresponding information.

Objects are items that exist in different areas of the map objectively. Different areas include different objects, and the number of objects is very large. Since the objects displayed in the map area are based on the user in the map area recommendation, it is necessary to recommend objects according to user feature, instead of recommending all the objects in the area to the user.

At present, the solution for map area recommendation is mainly recommended based on the user's fixed portrait. The user's fixed portrait can include, for example, the user's address, the community or business district that the user often goes to, whether the user travels by car or bus, etc. Through the user's fixed portrait, the objects to be recommended are determined, and then the objects to be recommended are displayed on the map area for users to view.

The disadvantage of the above solution is that determines the objects to be recommended and recommends the corresponding map area only according to the user's fixed portrait, its dimension is relatively limited, information such as scene, user's historical operation, especially information about user's recent historical operation, are ignored. For example, it can be learned that the user often goes to point A according to the user's fixed portrait. Then the recommended map area may mainly include the objects near point A according to the present solution. However, the user has searched scenic spots near point B for many times in the past two days, the user may be more interested in scenic spots near point B in the near future. If the present map area recommendation solution is adopted, effective recommendation for the user cannot be realized.

At the same time, the present map area recommendation solutions all update the recommended map area on a daily basis, its timeliness is poor, and it cannot be quickly and effectively recommended based on the user's real-time behavior.

Based on the above problems, embodiments of the present application provide a solution for map area recommendation, which can update the recommended map area according to the real-time behavior of user, so as to achieve the map area recommendation with more timely.

Solution of the present application will be described below taken in conjunction with the accompanying drawings.

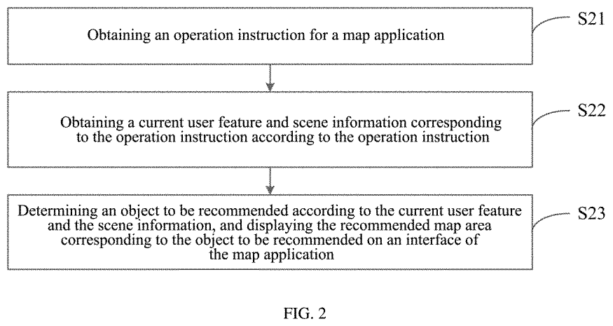

FIG. 2 is a flow diagram of a method for recommending a map area provided by embodiment of the present application, as shown in FIG. 2, the method may include:

S21, obtaining an operation instruction for a map application.

The execution body of the embodiments of the present application can be a terminal device, such as a mobile phone, a computer, etc. A map application is installed on the terminal device, and a user can operate the map application.

An operation instruction is the operation instruction that the user acts on the map application, and the operation instruction is a real-time behavior of the user. When the user acts on the map application through the operation instruction, the terminal device obtains the operation instruction for the map application.

S22, obtaining a current user feature and scene information corresponding to the operation instruction according to the operation instruction.

After obtaining the operation instruction, the current user feature and the scene information corresponding to the operation instruction can be obtained according to the operation instruction. In the embodiments of the present application, the current user feature is obtained according to the operation instruction, and the operation instruction is the real-time behavior of user, that is, the current user feature is obtained based on the real-time behavior of user.

The scene information may include information about time dimension and/or region dimension. After obtaining the operation instruction, the information about time dimension and/or region dimension corresponding to the operation instruction can be determined.

S23, determining an object to be recommended according to the current user feature and the scene information, and displaying a recommended map area corresponding to the object to be recommended on an interface of the map application.

After determining the current user feature and the scene information, the object to be recommended can be determined according to the current user feature and the scene information. In the embodiments of the present application, the map area of the map includes multiple objects, and the map area is divided in the form of grid. Different grids may include different objects, that is, each object has corresponding location information.

The objects can be POI points, news, videos, etc. The object to be recommended is determined according to the current user feature and the scene information, and needs to be displayed to user. After the object to be recommended is determined, the recommended map area corresponding to the object to be recommended can be displayed on the interface of the map application. The recommended map area includes the above object to be recommended. Users can click the corresponding object to be recommended on the interface of the map application for further learning.

The method for recommending a map area provided by the embodiment of the present application, firstly obtain an operation instruction for a map application, the operation instruction is a real-time behavior of a user, then obtain a current user feature and scene information corresponding to the operation instruction according to the operation instruction, and determine an object to be recommended according to the current user feature and the scene information, so as to display a recommended map area corresponding to the object to be recommended on an interface of the map application. The solutions of the embodiments of the present application determine the corresponding object to be recommended through the operation instruction, so as to determine the corresponding recommended map area. Since the operation instruction is a real-time behavior of the user, the map area can be recommended according to the real-time behavior of the user, and the real-time behavior of the user can be quickly reflected on the interface of the final recommended map area, realizing real-time recommendation of the map area, with high timeliness and improving the quality of the map area recommendation.

The solutions of the present application will be described in detail below taken in conjunction with the accompanying drawings.

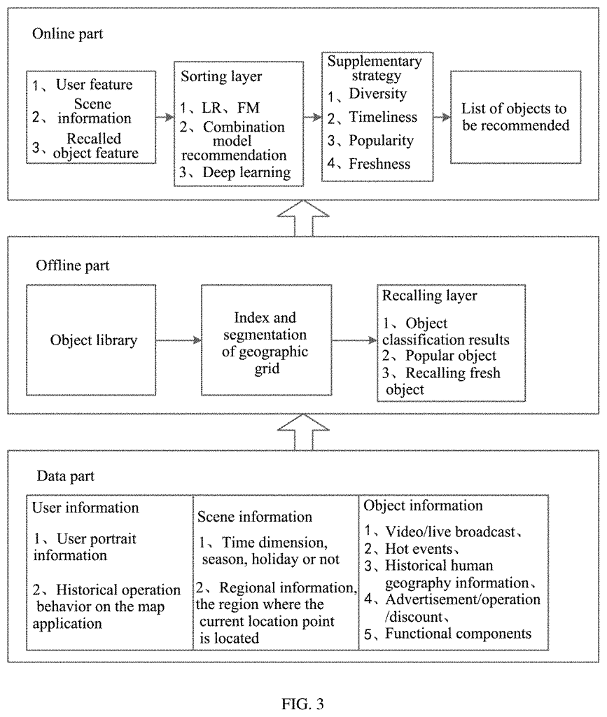

FIG. 3 is a schematic diagram of an area recommendation provided by embodiment of the present application, as shown in FIG. 3, in the embodiments of the present application, map area recommendation mainly involves three parts: a data part, an offline part and an online part.

The data part mainly involves the acquisition of the user information, the acquisition of the scene information and the acquisition of the object information.

The user is the operator of the map application, and the person who needs to be recommended the map area on the map application. The user information may include a variety of cases. For example, in FIG. 3, several possible cases of the user information are illustrated, such as user portrait information and historical operation behavior of user on the map application.

The user portrait information is relevant information obtained according to various behaviors of the user. The user portrait information, for example, can include user's address, company address, where the user often goes, whether the user travels by car or bus, etc. The user portrait information is relevant information obtained according to operation behavior of the user in a long period of time. The historical operation behavior of user on the map application can include, for example, navigation information, click information, retrieval information and so on which the user does in the map. In the embodiments of the present application, the historical operation behavior of user on the map application generally refers to the historical operation behavior in a recent period of time. The user portrait information and the historical operation behavior of user on the map application are both a reflection of the user feature.

The scene information can also include several different dimensions, such as time dimension, region dimension, etc. In FIG. 3, several possible cases of the scene information are illustrated. For example, in the time dimension, season and holiday or not can be included, in the regional dimension, the user's travel information and the regional features of the current location point can be included. The scene information can also affect the recommendation of the object on the map area.

For example, in the case of the object is a scenic spot, in the time dimension, if it is a holiday, the scenic spot may be more popular and the user may be more interested, if it is not a holiday, there may be fewer people go to the scenic spot and the user may be less interested. For example, in the case of the user is located in city A, in the regional dimension, the user may be more prefer to obtain objects in some areas of city A, but not interested in the objects in other places. Since there are different objects included in different areas, the final object to be recommended will also be affected according to the regional dimension in the scene information.

The object information mainly refers to information about the object included in the map area. There may be many kinds of objects. For example, several objects of the example in FIG. 3 include: video/live broadcast, hot events or news, historical human geography information, advertisement/operation/discount, functional components, etc.

The offline part is mainly for the object on the map area. The map area is divided in the form of grid, and there are different objects in different areas. The objects of different areas can be determined according to the index and segmentation of geographic grid in an object library. A recalling layer mainly recalls some objects in the object library. Since the objective existence of objects and the large number of objects, it is impossible to recall all objects.

In the embodiments of the present application, objects can be classified, and parts of the recalled objects in each classification are determined. Popular or fresh objects in the object library can also be recalled. Among them, the popular objects are the objects that users pay more attention to, such as some popular scenic spots, popular restaurants and so on. Fresh objects are mainly for some objects with high timeliness. For example, some timeliness news can be recalled when it just appears, and can be removed after the timeliness has run.

The online part is mainly for a real-time behavior of the user. That is because it is necessary to determine the list of the objects to be recommended before recommending the map area for the user, and the list of the objects to be recommended is updated through the real-time behavior of the user.

In the embodiments of the present application, firstly obtaining the user feature and the scene information, as well as the recalled object feature. Among them, the user feature is determined according to the real-time behavior of the user, so this part belongs to the online part and needs to be updated in real-time. The recalled object feature can be updated offline every certain period of time, so this part belongs to the offline part.

After obtaining the user feature, the scene information and the object feature, the current user feature can be obtained according to the user feature and the scene information, and the current user feature and object feature can be represented by corresponding feature vectors. Then a sorting layer can sort the object features according to the current user feature in some ways, such as logistic regression (LR), factorization machine (FM), combination model recommendation, deep learning and so on. A supplementary strategy is mainly to supplement some object types, for example, factors such as diversity, timeliness, popularity and freshness of the objects can be comprehensively considered to determine the list of objects to be recommended.

FIG. 4 is a flow diagram of obtaining a current user feature and scene information provided by embodiment of the present application, as shown in FIG. 4, including:

S41, determining an operation type of the operation instruction for the map application.

Since it is necessary to quickly reflect the real-time behavior of the user to the result of the map area recommendation in the embodiments of the present application, and the operation instruction is the real-time behavior of the user. Therefore, it is necessary to firstly determine the real-time behavior of the user, that is, to determine the operation type corresponding to the operation instruction.

The current user feature and corresponding scene information can be obtained according to the operation instruction. Different operation types of operation instructions may have different current user feature and corresponding scene information.

S42, obtaining the current user feature and the scene information according to the operation type.

After determining the operation type of the operation instruction for the map application, the current user feature and the scene information can be obtained according to the operation type. The following explains in combination with the different types of operations separately.

In a case that the operation type is an instruction to open the map application, specifically, a current location, a current time instant, user portrait information and operation history information in a first period can be obtained according to the instruction for opening the map application.

Among them, the current location is the user's current location located by the map application, the current time instant is the time instant when the user opens the map application, the operation history information in the first period includes the historical operation of the user on the map application in the first period, and the historical operation can include click, search and other historical operations on the map application.

The time difference between a start time instant of the first period and the current time instant is less than or equal to a first threshold, that is, the first period is a period that the time interval to the current time instant is less than or equal to the first threshold. For example, the first period can be the last two days or the last one day.

Setting the time difference between the start time instant of the first period and the current time instant is less than or equal to the first threshold is because the recent operation history information of the user may be more relevant to the object to be recommended in the map area that the user wants to obtain this time, while the operation history information with a longer time interval may be less relativity to the object to be recommended in the map area that the user wants to obtain this time. Therefore, only the recent operation history information of the user can be obtained.

After obtaining the current location, the current time, the user portrait information and the operation history information in the first period, the current user feature is obtained according to at least one of the user portrait information and the operation history information in the first period, and the scene information is obtained according to at least one of the current position and the current time instant.

In a case that the operation type is a click instruction for the map application interface, specifically, a click position information, a click time instant, user portrait information and operation history information in a second period can be obtained according to the click instruction.

Among them, the click position information is the location the user clicked on the interface of the map application, and the click time instant is the time instant when the user executes the click instruction, the operation history information in the second period includes the historical operation of the user on the map application in the second period, and the historical operation can include click, search and other historical operations on the map application.

The time difference between a start time instant of the second period and the click time instant is less than or equal to a second threshold, that is, the second period is a period that the time interval to the click time instant is less than or equal to the second threshold. For example, the second period can be the last two days or the last one day from the click time instant. The second threshold may be the same as or different from the first threshold.

Setting the time difference between the start time instant of the second period and the click time instant is less than or equal to the second threshold is also for obtaining the recent operation history information of the user at the click time instant, and exclude the operation history information of the user with a longer time interval from the click time instant, so as to obtain the operation history information with higher relativity.

After obtaining the click position information, the click time instant, the user portrait information and the operation history information in the second period, the current user feature is obtained according to at least one of the user portrait information and the operation history information in the second period, and the scene information is obtained according to at least one of the click position information and the click time instant.

In a case that the operation type is a search instruction, specifically, a current location, a search text, a current position, a search time instant, user portrait information and operation history information in a third period can be obtained according to the search instruction.

Among them, the search text is the text entered by the user during the search, the current location is the user's current location located by the map application, the search time instant is the time when the user executes the search instruction, the operation history information in the first period includes the historical operation of the user on the map application in the third period, and the historical operation can include click, search and other historical operations on the map application.

The time difference between a start time instant of the third period and the search time instant is less than or equal to a third threshold, that is, the third period is a period that the time interval to the search time instant is less than or equal to the third threshold. For example, the third period can be the last two days or the last one day from the search time instant. The third threshold may be the same as or different from the first threshold or the second threshold.

Setting the time difference between the start time instant of the third period and the start time instant is less than or equal to the third threshold is also for obtaining the recent operation history information of the user at the search time instant, and exclude the operation history information of the user with a longer time interval from the search time instant, so as to obtain the operation history information with higher relativity.

After obtaining the search instruction and obtaining the search text, the current location, the search time instant, the user portrait information and the operation history information in the third period, the current user feature is obtained according to at least one of the search text, the user portrait information and the operation history information in the third period, and the scene information is obtained according to at least one of the current position and the search time instant.

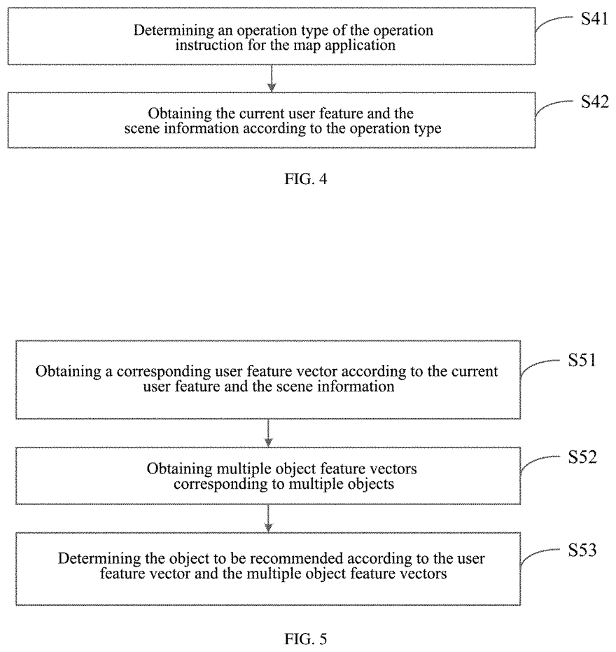

After obtaining the current user feature and the scene information according to the operation type of the operation instruction, the object to be recommended can be determined according to the current user feature and the scene information. The following explains in combination with FIG. 5.

FIG. 5 is a flow diagram of determining an object to be recommended provided by embodiment of the present application, as shown in FIG. 5, including:

S51, obtaining a corresponding user feature vector according to the current user feature and the scene information.

After determining the current user feature and the scene information, a corresponding user feature vector can be obtained according to the current user feature and the scene information. Since the current user feature is updated in real-time according to the real-time behavior of the user, i.e., the operation instruction, the corresponding user feature vector is also updated in real-time according to the real-time behavior of the user.

S52, obtaining multiple object feature vectors corresponding to multiple objects.

Since the map area is divided in the form of grid and the respective objects are located in different positions on the map area, each grid may include different number of objects. If the object in the map area is obtained directly, when the map area displayed on the interface of the map application is translated, new object need to be obtained according to the new map area. When a large number of users perform the above operation, it will lead to a large number of requests for supporting graph of the map area. For example, the corresponding queries per second (qps) can even reach 30000. The large number of requests for supporting graph will lead to a longer delay of the map area recommendation.

In the present application, the object is directly converted into the corresponding object feature vector, the speed of obtaining the object feature vector is correspondingly faster, lead to a shorter delay of the map area recommendation.

S53, determining the object to be recommended according to the user feature vector and the multiple object feature vectors.

After obtaining the user feature vector and multiple object feature vectors, a distance between each object feature vector and the user feature vector can be obtained, and then the objects corresponding to each of the object feature vectors can be sorted according to the distance between each object feature vector and the user feature vector to obtain a plurality of sorted objects.

It can be sorted in the order of distance from short to long when sorting. The closer the distance between the object feature vector and the user feature vector is, the more interested the user is in the object corresponding to the object feature vector.

After getting the plurality of sorted objects, preset number of objects at the top of the order can be determined as the objects to be recommended.

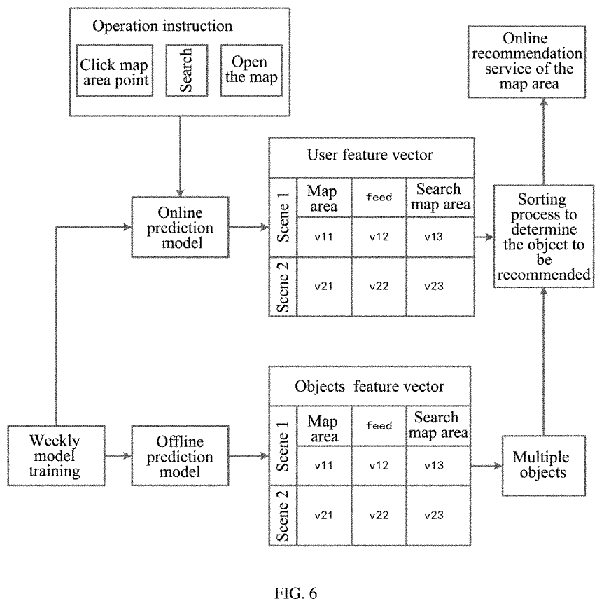

The following is exemplary descriptions of the process of map area recommendation with reference to FIG. 6.

FIG. 6 is a schematic diagram of a map area recommendation provided by embodiment of the present application, as shown in FIG. 6, in embodiments of the present application, the operation type of the operation instruction may include the instruction to open the map application, the click instruction for the interface of the map application (i.e., the click map area point in FIG. 6) or the search instruction.

The user feature vector and object feature vector can be trained by model. In FIG. 6, weekly model training, offline prediction model and online prediction model are included. Among them, weekly model training is a module, which is trained by machine learning algorithms based on week. The input is the user feature and the output is a model file when loading this module. This model file is the input of online prediction model and offline prediction model.

The user feature vector can be obtained by inputting the model file into the online prediction model. For example, in FIG. 6, user feature vectors corresponding to a map area, a feed and a search map area in scene 1, and user feature vectors corresponding to a map area, a feed and a search map area in scene 2 can be obtained through the online prediction model. The object feature vector can be obtained by inputting the model file into the offline prediction model. For example, in FIG. 6, object feature vectors corresponding to a map area, a feed and a search map area in scene 1, and object feature vectors corresponding to a map area, a feed and a search map area in scene 2 can be obtained through the offline prediction model. The corresponding multiple objects is determined by the object feature vector, and then the multiple objects are sorted according to the user feature vector, to get a final list of objects to be recommended, and then the online recommendation service of the map area can be carried out.

Among them, since the included objects in the map area are usually updated less frequently, so the updating of the objects can be offline. Specifically, the objects in the map application can be updated according to a preset time interval, and then updating the corresponding object feature vectors according to the updated objects. Through offline updating, it can also reduce the amount of calculation and improve the speed of online recommendation.

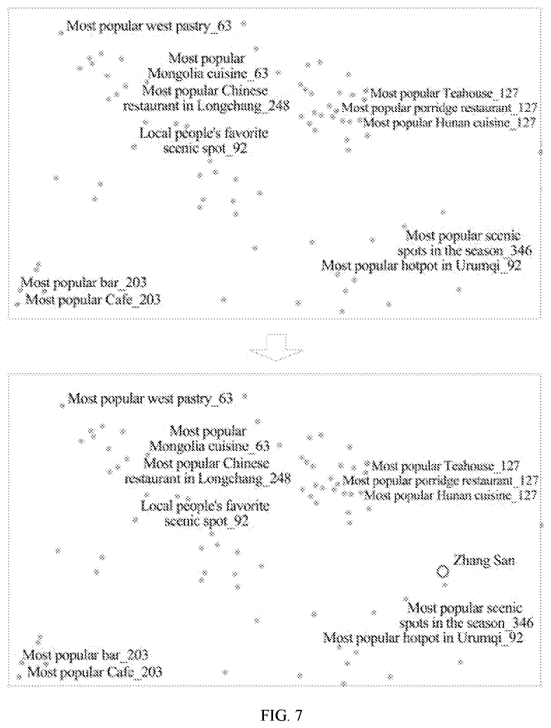

Sorting the objects corresponding to the object feature vector by the user feature vector can be determined by calculating the distance between the vectors. FIG. 7 is a diagram of determining an object to be recommended provided by embodiment of the present application, as shown in the upper part of FIG. 7, multiple objects within a certain map area is illustrated, in which each point represents an object. Specific contents of some objects are shown in FIG. 7, such as “most popular west pastry_63”, “local people's favorite scenic spot_92”, “most popular Hunan cuisine_127” and so on, where the number behind represents the object feature vector of the object. The object feature vectors of each object are different due to different positions of each object.

Then the user feature vector can be obtained according to the current user feature and scene information. As shown in the upper part of FIG. 7, an example of the user feature vector is “Zhang San”, and the user feature vector also has corresponding positions on the interface. Then the object to be recommended is determined according to the user feature vector and distance between the above object feature vectors. For example, in FIG. 7, the top three objects corresponding to the object feature vector closest to the user feature vector are “most popular scenic spots in the season”, “most popular hotpot in Urumqi” and “most popular Hunan cuisine”. If it is determined that there are three objects to be recommended in the end, the final objects to be recommended are “most popular scenic spots in the season”, “most popular hotpot in Urumqi” and “most popular Hunan cuisine”.

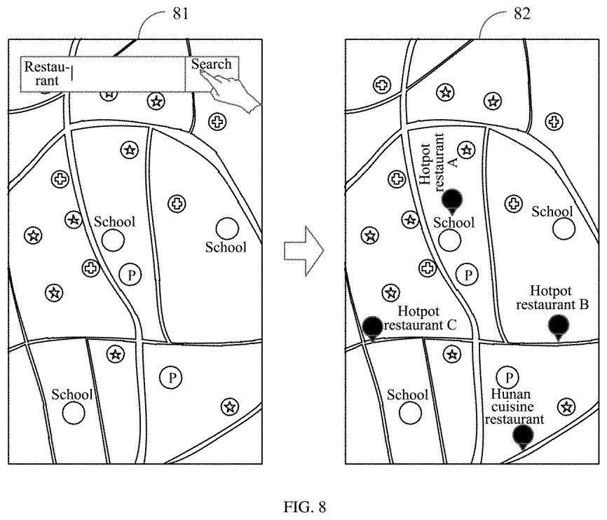

FIG. 8 is a schematic diagram of a map area recommendation interface provided by embodiment of the present application, as shown in FIG. 8, taking the user operation instruction is the search instruction as an example, on the interface 81, the user enters the search text “restaurant”, and then the search is performed.

The terminal device can obtain the search text “restaurant” and know that the user wants to find the “restaurant”. Combined with the user's recent historical operation information, for example, the user has searched the “hotpot restaurant” recently, the final object to be recommended is jointly determined.

According to the user's search instruction, the terminal device recommends the map area and obtains the corresponding map area recommendation interface 82, as shown in FIG. 8. Among them, the area recommendation interface 82 displays four objects, namely, hotpot restaurant A, hotpot restaurant B, hotpot restaurant C and Hunan cuisine restaurant.

The interface in FIG. 8 is only an example of map area recommendation, and does not constitute the limitation of the actual interface effect.

The method for recommending a map area provided by embodiment of the present application, firstly obtain an operation instruction for a map application, the operation instruction is a real-time behavior of a user, then obtain a current user feature and scene information corresponding to the operation instruction according to the operation instruction, and determine an object to be recommended according to the current user feature and the scene information, so as to display a recommended map area corresponding to the object to be recommended on an interface of the map application. The solutions of the embodiments of the present application determine the corresponding object to be recommended through the operation instruction, so as to determine the corresponding recommended map area. Since the operation instruction is a real-time behavior of the user, the map area can be recommended according to the real-time behavior of the user, and the real-time behavior of the user can be quickly reflected on the interface of the final recommended map area, realizing real-time recommendation of the map area, with high timeliness and improving the quality of the map area recommendation.

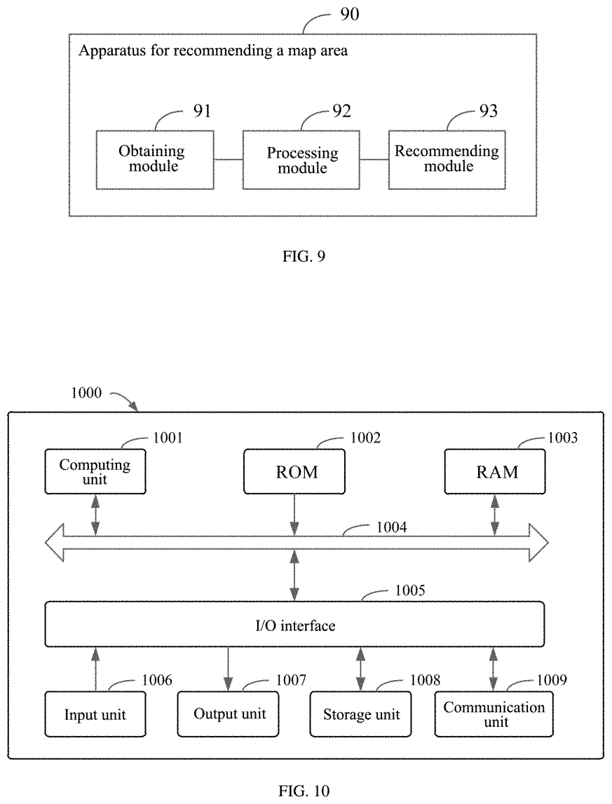

FIG. 9 is a structural diagram of an apparatus for recommending a map area provided by embodiment of the present application, as shown in FIG. 2, the apparatus 90 includes:

an obtaining module 91, configured to obtain an operation instruction for a map application;

a processing module 92, configured to obtain a current user feature and scene information corresponding to the operation instruction according to the operation instruction; and

a recommending module 93, configured to determine an object to be recommended according to the current user feature and the scene information, and displaying a recommended map area corresponding to the object to be recommended on an interface of the map application.

In one possible implementation, the processing module 92 includes:

a first determining unit, configured to determine an operation type of the operation instruction for the map application; and

a first obtaining unit, configured to obtain the current user feature and the scene information according to the operation type.

In one possible implementation, the operation type is an instruction to open the map application; the first obtaining unit includes:

a first obtaining subunit, configured to obtain a current location, a current time instant, user portrait information and operation history information in a first period according to the instruction for opening the map application, wherein the time difference between a start time instant of the first period and the current time instant is less than or equal to a first threshold;

a first processing subunit, configured to obtain the current user feature according to at least one of the user portrait information and the operation history information in the first period; and

a second processing subunit, configured to obtain the scene information according to at least one of the current location and the current time instant.

In one possible implementation, the operation type is a click instruction for the interface of the map application; the first obtaining unit includes:

a second obtaining subunit, configured to obtain a click position information, a click time instant, user portrait information and operation history information in a second period according to the click instruction, wherein the time difference between a start time instant of the second period and the click time instant is less than or equal to a second threshold;

a third processing subunit, configured to obtain the current user feature according to at least one of the user portrait information and the operation history information in the second period; and

a fourth processing subunit, configured to obtain the scene information according to at least one of the click position information and the click time instant.

In one possible implementation, the operation type is a search instruction; the first obtaining unit includes:

a third obtaining subunit, configured to obtain a search text, a current location, a search time instant, user portrait information and operation history information in a third period according to the search instruction, wherein the time difference between a start time instant of the third period and the search time instant is less than or equal to a third threshold;

a fifth processing subunit, configured to obtain the current user feature according to at least one of the search text, the user portrait information and the operation history information in the third period; and

a sixth processing subunit, configured to obtain the scene information according to at least one of the current location and the search time instant.

In one possible implementation, the recommending module 93 includes:

a second obtaining unit, configured to obtain a corresponding user feature vector according to the current user feature and the scene information;

a third obtaining unit, configured to obtain multiple object feature vectors corresponding to multiple objects; and

a second determining unit, configured to determine the object to be recommended according to the user feature vector and the multiple object feature vectors.

In one possible implementation, the second determining unit includes:

a fourth obtaining subunit, configured to obtain a distance between each object feature vector and the user feature vector;

a sorting subunit, configured to sort the objects corresponding to each of the object feature vectors according to the distance to obtain a plurality of sorted objects; and

a determining subunit, configured to determine the object to be recommended according to the plurality of sorted objects.

In one possible implementation, further including an updating module, the updating module includes:

a first updating unit, configured to update the objects in the map application according to a preset time interval; and

a second updating unit, configured to update the corresponding object feature vectors according to the updated objects.

The apparatus for recommending a map area provided by embodiment of the present application is configured to implement the above method embodiment, and its implementation principle and technical effect are similar and the present embodiment will not be repeated herein.

According to embodiments of the present application, the present application also provides an electronic device and a readable storage medium.

According to embodiments of the present application, the present application also provides a computer program product, the computer program product includes: a computer program, the computer program is stored in readable storage medium, at least one processors of the electronic device can read the computer program from the readable storage medium, the at least one processors executes the computer program enable the electronic device to execute the solution provided by any one of the above embodiments.

FIG. 10 shows a schematic block diagram of an example electronic device 1000 that can be configured to implement embodiments of the present application. Electronic devices are designed to represent various forms of digital computers, such as laptop computers, desktop computers, worktables, personal digital assistants, servers, blade servers, main frames computers, and other suitable computers. Electronic devices can also represent various forms of mobile devices, such as personal digital assistants, cellular phones, smart phones, wearable devices and other similar computing devices. The components shown herein, their connections and relationships, and their functions are only examples and are not intended to limit the implementation of the present disclosure described and/or required herein.

As shown in FIG. 10, the electronic device 1000 includes a computing unit 1001, which may perform various appropriate actions and processes based on a computer program stored in a read-only memory (ROM) 1002 or a computer program loaded from a storage unit 1008 into a random access memory (RAM) 1003. In the RAM 1003, various programs and data required for the operation of the device 1000 can also be stored. The computing unit 1001, the Rom 1002 and the RAM 1003 are connected to each other through bus 1004. An input/output (I/O) interface 1005 is also connected to the bus 1004.

Multiple components in the device 1000 are connected to the I/O interface 1005, including: an input unit 1006, such as a keyboard, a mouse, etc.; an output unit 1007, such as various types of displays, loudspeakers, etc.; a storage unit 1008, such as a disk, an optical disk, etc.; and a communication unit 1009, such as a network card, a modem, a wireless communication a transceiver, etc. The communication unit 1009 allows the device 1000 to exchange information/data with other devices through a computer network such as the Internet and/or various telecommunication networks.

The computing unit 1001 may be various general-purpose and/or special-purpose processing components with processing and computing capabilities. Some examples of the computing unit 1001 include, but are not limited to, a central processing unit (CPU), a graphics processing unit (GPU), various dedicated artificial intelligence (AI) computing chips, various computing units running machine learning model algorithms, digital signal processor (DSP), and any appropriate processor, controller, microcontroller, etc. The computing unit 1001 performs the various methods and processes described above, such as the method for recommending a map area. For example, in some embodiments, the method for recommending a map area may be implemented as a computer software program, which is tangibly included in a machine-readable medium, such as the storage unit 1008. In some embodiments, part or all of the computer program may be loaded and/or installed on the device 1000 via the ROM 1002 and/or the communication unit 1009. When a computer program is loaded into the RAM 1003 and executed by the computing unit 1001, one or more steps of the method for recommending a map area described above may be performed. Alternatively, in other embodiments, the computing unit 1001 may be configured to perform the method for recommending a map area in any other appropriate manner (for example, by means of firmware).

Various implementations of the systems and technologies described above can be implemented in digital electronic circuit system, integrated circuit system, field programmable gate array (FPGA), application specific integrated circuit (ASIC), application specific standard product (ASSP), system on chip system (SOC), load programmable logic equipment (CPLD), computer hardware, firmware, software, and/or their combination. These various embodiments may include: being implemented in one or more computer programs, the one or more computer programs may be executed and/or interpreted on a programmable system including at least one programmable processor, which may be a dedicated or general purpose programmable processor, which may receive data and instructions from the storage system, at least one input device, and at least one output, and transmit data and instructions to the storage system, the at least one input device, and the at least one output device.

The program code used to implement the method of the present disclosure may be written in any combination of one or more programming languages. These program codes can be provided to the processors or controllers of a general purpose computer, a special purpose computer, or other programmable data processing device, so that when the program code is executed by the processors or controllers, the functions specified in the flowcharts and/or block diagrams is implemented. The program code can be executed completely on the machine, partially on the machine, partially on the machine as separate packages, partially on the remote machine, or completely on the remote machine or server.

In the context of the present disclosure, the machine-readable medium may be a tangible medium, which may include or store programs for use by the instruction execution system, apparatus, or device or in combination with the instruction execution system, apparatus, or device. The machine-readable medium may be a machine-readable signal medium or a machine-readable storage medium. The machine readable media may include, but not be limited to, electronic, magnetic, optical, electromagnetic, infrared, or semiconductor systems, apparatus, or device, or any suitable combination of the above. More specific examples of machine readable storage media will include electrical connections based on one or more wires, portable computer disks, hard disks, random access memory (RAM), read-only memory (ROM), erasable programmable read-only memory (EPROM or flash memory), optical fiber, convenient compact disk read-only memory (CD-ROM), optical storage device, magnetic storage device, or any suitable combination of the above.

In order to provide interaction with the user, the systems and technologies described herein may be implemented on a computer that has: a display device for displaying information to the user (for example, CRT (cathode ray tube) or LCD (liquid crystal display) monitor; and a keyboard and pointing device (for example, a mouse or a trackball), through which the user can use the keyboard and the pointing device to provide input to the computer. Other types of devices may also be used to provide interaction with the user; for example, feedback provided to the user may be any form of sensing feedback (for example, visual feedback, auditory feedback, or tactile feedback); and input from the user can be received in any form (including sound input, voice input or tactile input).

The systems and technologies described herein may be implemented in a computing system including a background component (for example, as a data server), or a computing system including a middleware component (for example, an application server), or a computing system including a front-end component (for example, a user computer with a graphical user interface or a web browser through which the user can interact with the implementation of the system and technology described herein), or includes such back-end component, middleware component, or any combination of front-end component in a computing system. The components of the system can be connected to each other through digital data communication in any form or medium (for example, a communication network). Examples of communication networks include: local area network (LAN), wide area network (WAN), and Internet.

The computer system may include clients and servers. Clients and servers are generally far away from each other and usually interact through a communication network. The relationship between the client and the server is generated by computer programs that run on the corresponding computer and have a client-server relationship with each other. The server can be a cloud server, also known as cloud computing server or cloud host. It is a host product in cloud computing service system, to solve the defects of traditional physical host and VPS service (Virtual Private Server, VPS) with large management difficulty and weak business expansion. The server can also be a server of a distributed system or a server combined with a block chain.

It should be understood that the steps can be reordered, added, or deleted using the various forms of processes shown above. For example, the steps recorded in the present application can be performed in parallel, sequentially, or in a different order, as long as the desired result of the technical solution disclosed in the present application can be realized, this is not limited herein.

The above specific implementation does not constitute a limitation on the scope of protection of the present application. It should be understood by those skilled in the art that various modifications, combinations, sub combinations and substitutions can be made according to design requirements and other factors. Any modification, equivalent replacement and improvement made within the spirit and principle of the present application shall be included in the protection scope of the present application.

What is claimed is:

1. A method for recommending a map area, comprising:
obtaining an operation instruction for a map application;
obtaining a current user feature and scene information corresponding to the operation instruction according to the operation instruction; and
determining an object to be recommended according to the current user feature and the scene information, and displaying a recommended map area corresponding to the object to be recommended on an interface of the map application.

2. The method according to claim 1, wherein the obtaining a current user feature and scene information corresponding to the operation instruction according to the operation instruction comprises:
determining an operation type of the operation instruction for the map application; and
obtaining the current user feature and the scene information according to the operation type.

3. The method according to claim 2, wherein the operation type is an instruction for opening the map application; the obtaining the current user feature and the scene information according to the operation type, comprising:
obtaining a current location, a current time instant, user portrait information and operation history information in a first period according to the instruction for opening the map application, wherein the time difference between a start time instant of the first period and the current time instant is less than or equal to a first threshold;
obtaining the current user feature according to at least one of the user portrait information and the operation history information in the first period; and
obtaining the scene information according to at least one of the current location and the current time instant.

4. The method according to claim 2, wherein the operation type is a click instruction for the interface of the map application; the obtaining the current user feature and the scene information according to the operation type comprises:
obtaining a click position information, a click time instant, user portrait information and operation history information in a second period according to the click instruction, wherein the time difference between a start time instant of the second period and the click time instant is less than or equal to a second threshold;
obtaining the current user feature according to at least one of the user portrait information and the operation history information in the second period; and
obtaining the scene information according to at least one of the click position information and the click time instant.

5. The method according to claim 2, wherein the operation type is a search instruction; the obtaining the current user feature and the scene information according to the operation type comprises:
obtaining a search text, a current location, a search time instant, user portrait information and operation history information in a third period according to the search instruction, wherein the time difference between a start time instant of the third period and the search time instant is less than or equal to a third threshold;
obtaining the current user feature according to at least one of the search text, the user portrait information and the operation history information in the third period; and
obtaining the scene information according to at least one of the current location and the search time instant.

6. The method according to claim 1, wherein the determining an object to be recommended according to the current user feature and the scene information comprises:
obtaining a corresponding user feature vector according to the current user feature and the scene information;
obtaining multiple object feature vectors corresponding to multiple objects; and
determining the object to be recommended according to the user feature vector and the multiple object feature vectors.

7. The method according to claim 6, wherein the determining the object to be recommended according to the user feature vector and the multiple object feature vectors comprises:
obtaining a distance between each object feature vector and the user feature vector;
sorting the objects corresponding to each of the object feature vectors according to the distance to obtain a plurality of sorted objects; and
determining the object to be recommended according to the plurality of sorted objects.

8. The method according to claim 6, wherein the method further comprises:
updating the objects in the map application according to a preset time interval; and
updating the corresponding object feature vectors according to the updated objects.

9. An electronic device, comprising: at least one processor and a memory communicatively connected to the at least one processor; wherein the memory stores instructions executable by the at least one processor, and the at least one processor, when executing the instructions, is configured to:
obtain an operation instruction for a map application;
obtain a current user feature and scene information corresponding to the operation instruction according to the operation instruction; and
determine an object to be recommended according to the current user feature and the scene information, and display the recommended map area corresponding to the object to be recommended on an interface of the map application.

10. The electronic device according to claim 9, wherein the at least one processor is further configured to:
determine an operation type of the operation instruction for the map application; and
obtain the current user feature and the scene information according to the operation type.

11. The electronic device according to claim 10, wherein the operation type is an instruction for opening the map application; the at least one processor is further configured to:
obtain a current location, a current time instant, user portrait information and operation history information in a first period according to the instruction for opening the map application, wherein the time difference between a start time instant of the first period and the current time instant is less than or equal to a first threshold;
obtain the current user feature according to at least one of the user portrait information and the operation history information in the first period; and
obtain the scene information according to at least one of the current location and the current time instant.

12. The electronic device according to claim 10, wherein the operation type is a click instruction for the interface of the map application; the at least one processor is further configured to:
obtain a click position information, a click time instant, user portrait information and operation history information in a second period according to the click instruction, wherein the time difference between a start time instant of the second period and the click time instant is less than or equal to a second threshold;
obtain the current user feature according to at least one of the user portrait information and the operation history information in the second period; and
obtain the scene information according to at least one of the click position information and the click time instant.

13. The electronic device according to claim 10, wherein the operation type is a search instruction; the at least one processor is further configured to:
obtain a search text, a current location, a search time instant, user portrait information and operation history information in a third period according to the search instruction, wherein the time difference between a start time instant of the third period and the search time instant is less than or equal to a third threshold;
obtain the current user feature according to at least one of the search text, the user portrait information and the operation history information in the third period; and
obtain the scene information according to at least one of the current location and the search time instant.

14. The electronic device according to claim 9, wherein the at least one processor is further configured to:
obtain a corresponding user feature vector according to the current user feature and the scene information;
obtain multiple object feature vectors corresponding to multiple objects; and
determine the object to be recommended according to the user feature vector and the multiple object feature vectors.

15. The electronic device according to claim 14, wherein the at least one processor is further configured to:
obtain a distance between each object feature vector and the user feature vector;
sort the objects corresponding to each of the object feature vectors according to the distance to obtain a plurality of sorted objects; and
determine the object to be recommended according to the plurality of sorted objects.

16. The electronic device according to claim 14, wherein the at least one processor is further configured to:
update the objects in the map application according to a preset time interval; and
update the corresponding object feature vectors according to the updated objects.

17. A non-transitory computer readable storage medium storing computer instructions, wherein the computer instructions are used to enable the computer to:
obtain an operation instruction for a map application;
obtain a current user feature and scene information corresponding to the operation instruction according to the operation instruction; and
determine an object to be recommended according to the current user feature and the scene information, and display the recommended map area corresponding to the object to be recommended on an interface of the map application.

18. The storage medium according to claim 17, wherein the computer instructions are further used to enable the computer to:
determine an operation type of the operation instruction for the map application; and
obtain the current user feature and the scene information according to the operation type.

19. The storage medium according to claim 18, wherein the operation type is an instruction for opening the map application; the computer instructions are further used to enable the computer to:
obtain a current location, a current time instant, user portrait information and operation history information in a first period according to the instruction for opening the map application, wherein the time difference between a start time instant of the first period and the current time instant is less than or equal to a first threshold;
obtain the current user feature according to at least one of the user portrait information and the operation history information in the first period; and
obtain the scene information according to at least one of the current location and the current time instant.

20. The storage medium according to claim 18, wherein the operation type is a click instruction for the interface of the map application; the computer instructions are further used to enable the computer to:
obtain a click position information, a click time instant, user portrait information and operation history information in a second period according to the click instruction, wherein the time difference between a start time instant of the second period and the click time instant is less than or equal to a second threshold;
obtain the current user feature according to at least one of the user portrait information and the operation history information in the second period; and
obtain the scene information according to at least one of the click position information and the click time instant.
